(19) United States
(12) Patent Application Publication
(10) Pub. No.: US 2013/0136822 A1
(43) Pub. Date: May 30, 2013

(54) CHEWING GUM BASES CONTAINING SOY PROTEIN BASED ELASTOMERS AND METHODS OF MAKING SAME

(71) Applicants: Xiaoqun Mo, Oak Park, IL (US); Jingping Liu, Indian Head Park, IL (US); Michael J. Greenberg, Northbrook, IL (US); Xiuzhi Sun, Manhattan, KS (US); Guangyan Qi, Manhattan, KS (US); Karthik Venkateshan, Bangalore (IN); Lu Zhang, Davis, CA (US)

(72) Inventors: Xiaoqun Mo, Oak Park, IL (US); Jingping Liu, Indian Head Park, IL (US); Michael J. Greenberg, Northbrook, IL (US); Xiuzhi Sun, Manhattan, KS (US); Guangyan Qi, Manhattan, KS (US); Karthik Venkateshan, Bangalore (IN); Lu Zhang, Davis, CA (US)

(73) Assignee: WM. WRIGLEY JR. COMPANY, Chicago, IL (US)

(21) Appl. No.: 13/420,751

(22) Filed: Mar. 15, 2012

Related U.S. Application Data
(60) Provisional application No. 61/452,782, filed on Mar. 15, 2011.

(51) Int. Cl. A23G 4/08

(52) U.S. Cl. CPC A23G 4/08
USPC 426/3

(57) ABSTRACT

An elastomer is prepared from fractions of soy protein. Methods for producing the elastomer and chewing gum bases containing the soy protein elastomer are provided.

### CROSS-REFERENCE TO RELATED APPLICATION

This application claims benefit to U.S. Provisional Application No. 61/452,782 filed Mar. 15, 2011, incorporated by reference herein.

### BACKGROUND OF THE INVENTION

As a natural polymer, soybean protein has been used extensively as an ingredient in food products such as beverages, whipped toppings, sausages, baking products, and tofu due to its functional properties, high nutritional value, and low cost.

It is well known that the dominant storage protein in soy bean is globulins, accounting for 50-90% of the protein. Soy globulins comprise two major components: glycinin (11S) and β-conglycinin (7S). The relative proportion of 11S to 7S ranges from 1:3 to 3:1 depending on the cultivar and growing condition. 11S globulin is a hexamer with molecular weight of about 350 kDa and consists of an acidic and basic polypeptide linked by disulfide bond. 7S is a trimer with molecular weight of 150-200 kDa, composed of three subunits: α, α′, and β. These subunits are non-covalently associated by hydrophobic interaction and hydrogen bonding without any disulfide bonds. Due to the inherent structure difference in 7S and 11S globulin, they exhibit different physicochemical functions of soy protein.

### SUMMARY OF THE INVENTION

The present invention is directed to gum bases containing an elastomer which is a fraction of protein extracted from soy and a method of preparing the elastomer.

The present invention is also directed to methods of preparing the elastomer

### BRIEF DESCRIPTION OF THE DRAWINGS

FIG. 1 is a Reducing SDS-PAGE pattern of soy proteins with different subunits ratio by virtue of their extraction pH: pH 5.1 (Comparative Run 1, Lane A); pH 5.4 (Example 2, Lane B); pH 5.6 (Example 3, Lane C); pH 5.8 (Comparative Run 4, Lane D); pH 6.0 (Comparative Run 5, Lane E) and pH 6.4 (Comparative Run 6, Lane F)

FIG. 2 is a Non-Reducing SDS-PAGE pattern of soy proteins with different subunits ratio by virtue of their extraction pH: pH 5.1 (Comparative Run 1, Lane A); pH 5.4 (Example 2, Lane B); pH 5.6 (Example 3, Lane C); pH 5.8 (Comparative Run 4, Lane D); pH 6.0 (Comparative Run 5, Lane E) and pH 6.4 (Comparative Run 6, Lane F)

FIG. 3 is a Non-Reducing SDS-PAGE pattern of soy protein elastomer treated with different chemicals: NaCl (lane A); urea (lane B); NaHSO3 (lane C)

FIG. 4 is a graph of elastic modulus and viscous modulus of soy protein with different subunits ratio as function of shear rate.

FIG. 5 is a graph of complex viscosity of soy protein with different subunits ratio as function of shear rate.

FIG. 6 is a series of DSC thermograms showing thermal denaturation of the soy protein extracts.

FIG. 7 A-D are TEM images of the soy protein extract of Comparative Run 1, Example 2, Comparative Run 4 and Comparative Run 6 respectively.

FIG. 8 A-D are SEM images of soy protein with different subunit ratios: pH 5.1-4.8 (A); pH 5.4-4.8 (B); pH 5.8-4.8 (C); pH 6.4-4.8 (D).

### DESCRIPTION OF THE INVENTION

The present invention is directed to a novel soy protein-based elastomer (SPE) with 40% solid content, to methods of preparing this SPE and to the use of this SPE as an elastomer in a chewing gum base.

The SPE of the present invention is very sticky, elastic, and extensible in its native state, which is similar to the viscoelastic properties of wheat gluten protein. Therefore, it displays good potential for many applications such as gluten-free baking products, candy bar, and films etc. It is further believed that this SPE can be especially useful in preparing gum bases which are biodegradable and therefore more environmentally friendly than conventional chewing gum base elastomers. Furthermore, the SPE of the present invention is derived from renewable plant sources rather than from petroleum.

In an embodiment, the present invention is a soy protein elastomer comprising a fraction of protein extracted from soy. In some embodiments, the soy protein elastomer is enriched in α and α′ subunits of β-conglycinin as compared to soy protein.

In an embodiment, the present invention is chewing gum base containing a soy protein elastomer comprising a fraction of protein extracted from soy. In some embodiments, the gum base contains a soy protein elastomer that is enriched in α and α′ subunits of β-conglycinin as compared to soy protein.

In an embodiment, the soy protein elastomer may be prepared by extracting a protein fraction from a native soy protein source such as soy flour using an aqueous solvent of pH between about 5.2 and about 5.7. In an embodiment, the elastomer is collected from the extraction solvent by adjusting the pH to the isoelectric point or lower to precipitate the SPE.

In an embodiment, the aqueous solvent has a pH between 5.3 and 5.6. In another embodiment, the pH of the aqueous solvent is between 5.3 and 5.5. In yet another embodiment, the pH of the aqueous solvent is about 5.4.

In some embodiments, the present invention is an SPE prepared according to any of the above methods. In some embodiments, the present invention is a chewing gum base containing any of these SPEs.

The dominant storage protein in soybean is globulin (50-90%), which has two major components: glycinin (11S) and β-conglycinin (7S). The relative proportion of 11S to 7S ranges from 1:3 to 3:1 depending on the cultivar and growing conditions. 11S globulin is a hexamer with molecular weight of about 350 kDa and consists of an acidic and basic polypeptide linked by disulfide bonds. 7S is a trimer with a molecular weight of 150-200 kDa that is composed of three subunits: α, α′, and β. These subunits are non-covalently associated by hydrophobic interaction and hydrogen bonding with no disulfide bonds. Due to inherent structure differences in 7S and 11S globulin, they perform different physicochemical functions in soy protein. The inventors have recognized that the physicochemical properties of extracted soy protein are likely affected by different ratios of 7S and 11S subunits, including electrophoresis, dynamic rheological, thermal, and morphological properties. Therefore, the rheological properties of SPEs, for example those properties which could convey desirable chewing properties to a chewing gum base, can be affected by manipulating the ratios of the soy protein components.

Soy protein elastomer (SPE) exhibits elastic, extensible, and sticky properties in its native state and displays great potential as an alternative to wheat gluten. To understand the mechanisms of how the soy protein subunits affect the functional properties of SPE, six soy protein samples with different compositions were produced by adjusting various extraction pH values. Based on the different solubility of 7S and 11S, pH values 5.1, 5.4, 5.6, 5.8, 6.0, and 6.4 were used to precipitate different amounts of 11S, then a series of final products were collected at pH 4.8. Electrophoresis results showed that a subunit content decreased as extraction pH increased. High-molecular-weight aggregates composed of α and α′ subunits connected through disulfide bonds were observed in the non-reducing SDS-PAGE profile; the amount of these aggregates decreased from 25% to 10% as the pH increased from 5.4 to 6.4. Soy protein samples with higher aggregate content displayed higher denaturation enthalpy in DSC thermogram and larger-size protein aggregation in TEM images. Soy protein extracted at pH 5.4 (SP5.4) exhibited much stronger viscoelastic solid behavior than other soy protein samples based on dynamic elastic and viscous modules. SEM results showed that SP5.4 exhibited the flat and smooth surface of protein particles, while other samples lack of viscoelasticity had the rough and fluctuant particle surfaces. The ability of α′ and α to form aggregates in soy proteins and the resultant proper protein-protein interaction are critical to the continuous network for SPE with high solid content (40%).

### EXAMPLES

Samples of soy protein extracts were created as follows:

Soy Protein Sample Extraction Procedure:

Soy flour obtained from Cargill (Cedar Rapids, Iowa) was dispersed in water at 6.25% solid content with pH 9.5. The dispersion was then centrifuged to remove the non-soluble components. Soy protein elastomer was obtained through the acid precipitation methods. Protein fractions were extracted at pH 5.1 (Comparative Run 1), pH 5.4 (Example 2), pH 5.6 (Example 3), pH 5.8 (Comparative Run 4), pH 6.0 (Comparative Run 5) and pH 6.4 (Comparative Run 6) followed by centrifugation to recover the precipitated product. The final products were collected by adjusting the pH to pH4.8 and collecting the precipitate. The extraction at various pH levels resulted in soy protein samples with different compositions, based on the solubility differential of glycinin and p-conglycinin subunits at differing pH levels.

Testing:

The above soy protein Examples/Comparative Runs were tested as follows:

Electrophoresis (SDS-PAGE):

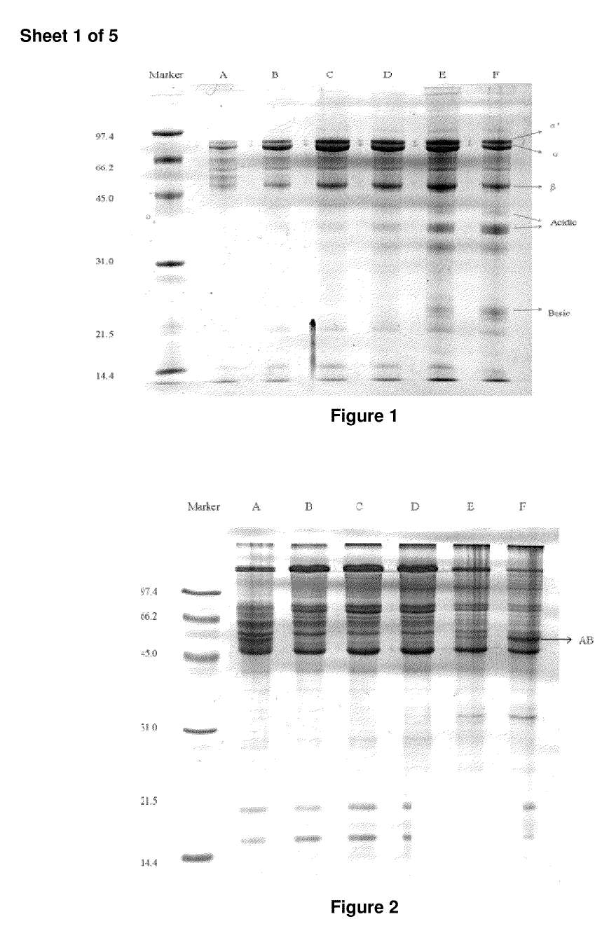

SDS-PAGE was performed on a 4% stacking gel and 12% separating gel with a discontinuous buffer system according to the method described by Laemmli (1970). Protein sample was mixed with a sample buffer containing 2% SDS, 25% glycerol, and 0.01% bromophenol blue. Reducing SDS-PAGE and Non-Reducing SDS-PAGE patterns are shown as FIGS. 1 and 2 respectively. From these it is apparent that the extracts of Examples 2 (pH 5.4) and 3 (pH 5.6) were enriched in α and α′ subunits of β-conglycinin as compared to soy protein.

To study the disulfide bonds in soy protein, SDS-PAGE was carried out under both reducing (β-Met) and non-reducing conditions. A total of 8 μg of protein was applied to sample slots. Molecular weight standards were run with the samples. Electrophoresis was preformed at 40 mA and 120 V for 90 min. The gel was stained in 0.25% Coomassie brilliant blue R-250 and destained in a solution containing 10% acetic acid and 40% methanol. Densitometry was obtained by analyzing the gel image using the Kodak 1D Image Analysis software, version 4.6 (Kodak, Rochester, N.Y.).

To study the forces involved in the formation of protein aggregates, soy protein extracted at pH 5.4 was treated with NaCl, urea, and n-Met. Dried SPE powder of 5 mg was dispersed in 10 ml of 0.2 M citric acid-Na2HPO4 buffer (pH 4.8) to make the suspension. Then 4% (dry basis) of NaCl, urea, and 0.02 M β-Met were added to the solution. After 2 hr stirring, the treated soy protein suspensions were centrifuged at 8,000×g for 15 min, and the precipitated insoluble SPE was lyophilized for the non-reducing electrophoresis.

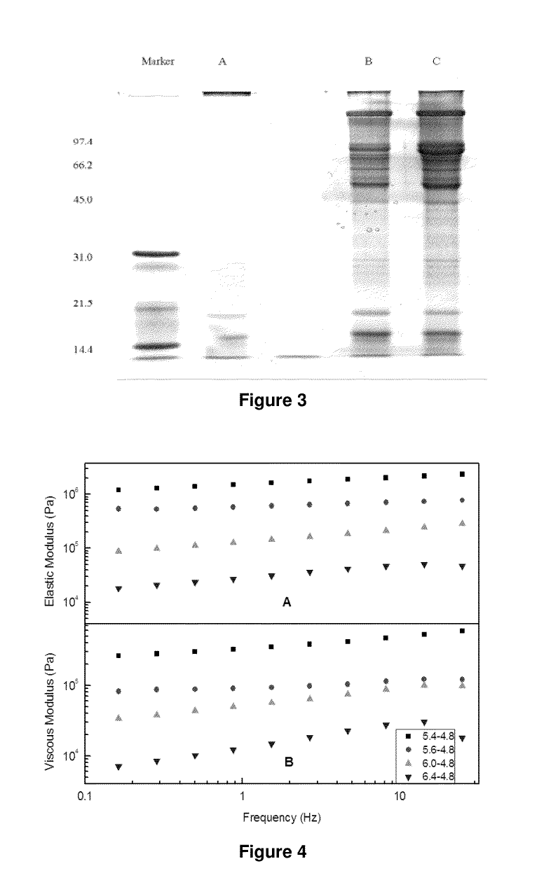

In order to study the forces involved in the stabilizing the protein aggregates, different chemicals were chosen to treat the soy protein elastomer, and then non-reducing SDS-PAGE pattern of soy protein elastomer (SPE) in the absence of 2-mercaptoethanol was performed. The non-reducing SDS-PAGE pattern is show as FIG. 3.

The reducing SDS-PAGE profiles of soy protein with different subunit ratios are shown in FIG. 1. The components in the soy protein are: α′, α, β subunits of β-conglycinin, acidic (A3, A1a, A1b, A2, and A4) and basic polypeptides (B3, B1a, B1b, B2, and B4) of glycinin. As shown in FIG. 1, 7S subunits with no 11S contamination were observed in SP5.1 and SP5.4 (lane A, B) samples, indicating that 7S and 11S could be fractionated at the pH of 5.1-5.4. When the extraction pH increased to 5.6, trace bands at 38 kDa and 23 kDa, corresponding to acidic and basic polypeptides of 11S, were observed, and the intensity increased as pH increased (FIG. 1, D-F). Thanh and Shibasaki pointed out that the major method of fractionation of soy proteins was based on their different solubilities. The 7S (precipitated at pH 4.0-5.6) and 11S (precipitated at pH 4.4-6.8) can be simultaneously fractionated in the pH region of 6.2-6.4, wherein most of the 7S dissolved but most of the 11S precipitated; then 7S can be separated by adjusting pH to 4.8. However, the cross-contamination of 7S and 11S always happened to different extents during fractionating. In our protein extraction procedure, all of 11S and part of 7S were precipitated and removed at extraction pH 5.1-5.4, resulting in the pure 7S globulin at pH 4.8, but at the expense of protein yields (8% wet basis for SP5.4).

The amount of glycinin fraction increased from 0.9% for sample SP5.6 to around 37% for sample SP6.4 (Table 1). The percentages of α′ and β subunits had the relatively constant value of about 18%, whereas the content of a decreased from 50% to 20% as pH increased from 5.1 to 6.4. Nakamura et al. reported that the percentages of α′, α, and β subunits in the native 7S were 37.5%, 25%, and 37.5%, respectively, which also was similar to the ratio of protein subunits used in this study. Our data indicated that the percentages of those three subunits in soy protein changed during extraction, probably due to the different isoelectric points of 7S subunits: 5.2, 4.9 and 5.7-6.0 for α′, α, and β, respectively. The rearranged protein subunits could significantly affect the protein's functionality.

Non-reducing SDS-PAGE in the absence of β-Met was performed to study the disulfide linkage in soy protein (FIG. 2). There were bands on top of stacking gels and resolving gels, which could be the aggregates of α′ and α subunits, because α′+α subunit content decreased to less than 20% in non-reducing SDS-PAGE (Table 2) from more than 36% in reducing SDS PAGE (Table 1). The percentage of β subunit remained in the range of 25-33% compared to 20% under reducing SDS-PAGE, indicating that β subunit did not participate in the formation of aggregation. In addition, the band intensity for aggregates decreased gradually as the pH increased from 5.4 to 6.4, accompanied by the decreased β-conglycinin component in the protein samples. High-molecular-weight aggregation induced by α′ and α also were observed by other researchers, but in a very small quantity. Silvana suggested that both electrostatic interaction and disulfide bonds existed in the aggregates. Moreover, the intensity of several small bands at around 100 kDa increased as the 11S content increased. These bands could be the disulfide bond-linked polymers caused by freeze-drying or thiol-disulfide exchange in glycinin, they faded when reducing SDS-PAGE was performed.

To understand the chemical forces involved in the formation of soy protein aggregates, sample SP5.4 was treated with 4% NaCl, urea, and 0.02M β-Met, then carried out with non-reducing SDS-PAGE (FIG. 3). The percentages of the aggregates and polypeptides are shown in Table 3. Sodium chloride-treated soy protein showed an increase in aggregates content to 31% compared to 25% in the control, whereas a′ and a subunits content decreased to 8% compared to 16% in the control. Sodium chloride reduces electrostatic repulsion among soy protein molecules through the effects of charge neutralization, suggesting that electrostatic interactions are involved in soy protein aggregate formation. Urea-treated soy protein showed similar results: the increase of aggregates contents with concomitant decrease of α′ and α subunit content, suggesting that hydrogen bonding and hydrophobic interactions have limited effects on protein aggregate formation; because urea is known to disrupt those interactions in protein. β-Met-treated soy protein showed a decrease in protein aggregate content of 15%, indicating that disulfide bonds are involved in the aggregates. Furthermore, almost 40% of sample SP5.4 was solubilized by β-Met, demonstrating that the disulfide bond is also essential in maintaining the protein network.

Dynamic Viscoelastic Measurement:

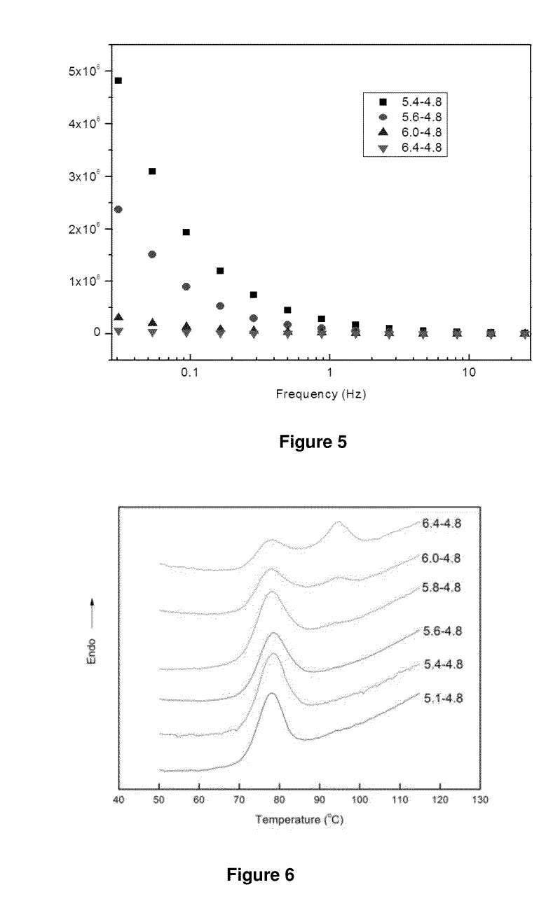

A Bohlin CVOR 150 rheometer was used to perform the dynamic oscillatory shear testing of soy protein samples. Parallel plate head was used with 8 mm plate diameter and 1 mm gap. The measurements were performed in a strain controlled mode wherein the amplitude of shear strain was 0.5% and the frequency range was from 0.01 to 25 Hz. Graphs of elastic modulus and viscous modulus of soy protein with different subunits ratio as function of shear rate and of complex viscosity of soy protein with different subunits ratio as function of shear rate are shown as FIGS. 4 and 5 respectively. As can be seen, Examples 2 and 3 extracted at 5.4 and 5.6 pH showed significant elastomeric properties.

Dynamic rheological measurement is a useful method to study the viscoelastic properties of polymers. It can be carried out at a small strain within the linear viscoelastic region; the modulus curves can be monitored as a function of time and frequency. FIG. 4 shows the frequency dependence of the storage modulus (G′) and loss modulus (G″) of soy protein with different subunit ratios. Shear modulus of soy protein exhibited weak frequency-dependent behavior; G′ and G″ increased as the frequency increased because of decreased time for stress relaxation during the shearing with the increased frequency. Sample SP5.4 exhibited much stronger viscoelastic solid behavior than other samples. It had the highest shear modulus (ranged from 4.5×105 Pa to 2.4×105 Pa for elastic modulus, 1.6×105 Pa to 2.6×105 Pa for viscous modulus, respectively) among all the samples under the same shear condition. Moreover, the elastic modulus predominated over viscous modulus by an order of magnitude at the frequency range, indicating more elastic properties of sample SP5.4. Those findings are in agreement with Utsumi et al., who found that β-conglycinin largely contributed to the elasticity of the gels, whereas glycinin was related to hardness and unfracturability of the gels.

Complex viscosity represents the true viscoelastic characteristics of gels. Same with the dynamic modulus, sample SP5.4 had the highest complex viscosity (FIG. 5), suggesting that strong intermolecular force existed in proteins. The viscosity of all samples decreased as the frequency increased, indicating that the proteins have shear thinning properties.

Differential Scanning Calorimetry (DSC):

Thermal denaturation properties of soy protein samples were assessed with a differential scanning calorimeter (DSC7, Perkin-Elmer, Norwalk, Conn.) calibrated with indium and zinc. The sample was held at 20° C. for 1 min and then scanned from 20° C. to 130° C. at a heating rate of 10° C./min. Peak temperatures (Td) and denaturation enthalpies (ΔH) are provided in Table 1 and the DSC thermograms are shown as FIG. 6.

TABLE 1

| Example/ | | | |
|---|---|---|---|
| Comparative | Extraction | T_{d} (° C.) | TotalΔH |

| Run | pH | 7s | 11s | (J/g) |
|---|---|---|---|---|
| CR 1 | 5.1-4.8 | 77.80 | — | 8.44 |
| Ex. 2 | 5.4-4.8 | 78.13 | — | 8.67 |
| Ex. 3 | 5.6-4.8 | 78.31 | — | 8.75 |
| CR 4 | 5.8-4.8 | 77.97 | 94.20 | 7.38 |
| CR 5 | 6.0-4.8 | 77.97 | 94.20 | 5.93 |
| CR 6 | 6.4-4.8 | 77.97 | 94.71 | 5.71 |

DSC is usually used to measure protein denaturation, which significantly affects protein functionality and its application in food. Soy protein thermal denaturation involves unfolding the quaternary, tertiary, and secondary structures, accompanied by extensive uptake of heat. Typical thermal denaturation peaks for 7S and 11S of soy protein samples with different subunit ratios were observed in DSC thermogram (FIG. 6). The endothermic transition peak for glycinin was observed at extraction pH higher than pH 5.8, suggesting that 11S was presented in samples extracted at those pHs, which is in agreement with SDS-PAGE results. The denaturation temperature (T_{d}) of 7S and 11S for all soy proteins were in the similar range of 77.8-78.3° C. and 94.2-94.7° C., respectively. The total enthalpy (ΔN) of soy protein increased as the pH decreased from 6.4 to 5.1; meanwhile, an increase of α′+α from 36% to 70% was observed (Table 1). The cysteines in α and α′ subunits induced the formation of disulfide-linked aggregation as observed in the non-reducing SDS-PAGE (FIG. 2). And the increased amount of disulfide-linked aggregates in soy protein (Table 2) improves protein thermal stability.

Transmission Electron Microscopy (TEM):

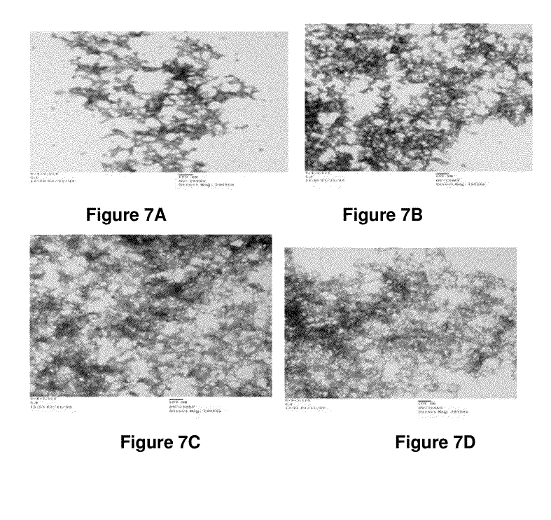

A Philips CM 100 (FEI Company, Hillsboro, Oreg.) TEM was used to observe microstructure of soy protein samples. All fresh soy protein samples were diluted to 1% with deionized water for imaging and sonicated for 10 min in an L&R320 ultrasonic stirrer. TEM images of Examples/Comparative Runs 1, 2, 4 and 6 are shown as FIGS. 7, 8, 9 and 10 respectively.

Morphological properties. The TEM images of soy protein samples are shown in FIG. 7. Chain-like structure and large protein aggregates were observed in sample SP5.1 (FIG. 7 a). Sample SP5.4 had an increased amount of small globular aggregates, and some of them grew into larger irregularly shaped clumps (as indicated by arrows in the image) (FIG. 4 b). As to the SP5.8 (FIG. 7 c), it showed further increase in the number of smaller globular protein aggregates and a decrease in size of irregularly shaped clumps. When the extraction pH increased to 6.4, mainly small globular protein aggregates with only a few large-size protein clumps were observed (FIG. 7 d). As explained in the SDS-PAGE section, high-molecular-weight aggregates composed of α′ and α subunits and stabilized by disulfide bonds were observed in soy protein samples, indicating the strong protein-protein interactions and displayed as the larger-size protein aggregates in TEM images. Therefore, with decreasing content of α′ and α subunits as extraction pH increased, the number of large-size protein aggregates decreased gradually (FIG. 7).

Phase and functionality differences in the soy protein samples are known to be partially attributable to several factors, such as protein-protein interactions, protein-water interactions, protein composition, and protein solid content etc. As evidenced in the non-reducing SDS-PAGE, disulfide bonds played a critical role in maintaining the stability of soy protein network, and the resultant strong protein-protein interactions might play the key role in the external physical phases. Water-protein interaction is an important factor in the dehydration, rehydration, solubility, viscosity, gelation, and other important properties of protein products. We assumed that sample SP5.4 had the proper protein-protein interaction, which could maintain the amount of water inside the protein structure that is crucial to the formation of continuous protein phases with viscoelastic properties. In the case of protein extracted at higher pH, the decreased protein aggregates in TEM images indicated the weaker protein network, which could not retain water as much as sample SP5.4; this poor water-holding ability also could be reflected by the squeezed-out water from those samples during storage (SP>5.4). Moreover, glycinin is known to have greater surface hydrophobicity than β-conglycinin due to more hydrophobic groups in glycinin, leading to poor water hydration properties. Therefore, the weak protein-protein interaction and poor hydration properties in protein samples SP>5.4 could lead to the clay-state phase without cohesiveness. All in all, proper protein-protein interactions with resultant entraining of the proper amount of water molecules are critical to continuous network for SPE with high solid content (40%).

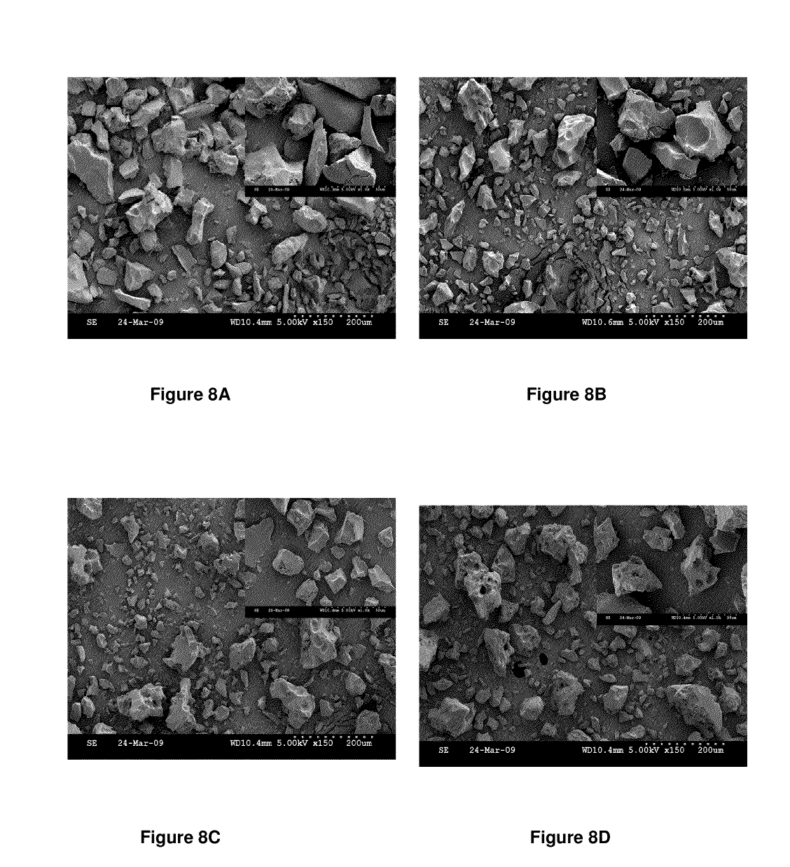

SEM images of soy protein samples with different subunit ratios are shown in FIG. 8. All soy proteins exhibited in the form of irregular compact chunks, but the surface morphology of the protein particles was different. Sample SP5.1 displayed the coarse surface (FIG. 8 a), whereas SP5.4 had the smooth surface with several dents on each particle (FIG. 8 b). By changing the soy protein compositions, the particle surface of sample SP5.8 still existed with some dents but with a rougher surface than SP5.4 particles (FIG. 8 c). When soy protein samples contained glycinin (SP6.4, FIG. 8 d), coarse, fluctuant surfaces with large holes inside were observed. Consistent with the results of dynamic viscoelasticity, the morphology of sample SP5.4 with the smooth surface indicated much stronger mechanical strength than other samples, whereas the fragile properties of clay-like proteins would have rough surfaces under mechanical force.

Water Absorbing Capacity (WAC):

Water absorbing capacity of soy protein sample was tested using the ultracentrifugation methods. The water absorbing capacity of soy protein was expressed as grams of absorbed water per gram of dried soy protein. Reported values in Table 2 are average of two measurements.

TABLE 2

| Example/CR | 1 | 2 | 4 | 6 |
|---|---|---|---|---|
| Water absorbing | 2.389 ± | 0.901 ± | 1.067 ± | 1.137 ± |
| ability | 0.08 | 0.04 | 0.16 | 0.14 |

Interpretation of Test Results

Reducing SDS-PAGE showed that the percentages of α, α′ and β subunits in soy protein were rearranged during the extraction. Some α′ and β subunits were resolved into water along with the glycinin in the first step of centrifuge (pH 5.1-6.4)

High molecular weight protein aggregates were mainly stabilized by the disulfide bond, while the hydrogen bonding and electrostatic force also play the role in aggregates formation in some extent.

Soy protein sample with higher content of disulfide bond induced aggregations had the higher denaturation enthalpy (DSC thermogram) and larger size of protein aggregation observed in TEM images, than the ones of lower aggregation content.

The SPE Examples 2 and 3 had the lowest WAC of the protein extracts, while Comparative Run 1 absorbed the greatest amount of water.

All in all, the proper protein-protein interactions with its resulting entraining proper water molecules are critical to continuous network for SPE with high solid content (40%).

Chewing gum bases can be made with any of the described SPEs. Bases using SPEs as the sole elastomer and as a blend with conventional elastomers such as butyl rubber and styrene butadiene rubber are both contemplated. In addition, other conventional gum base ingredients such as softeners, plasticizers, fillers plastic resins, elastomer solvents, colors and antioxidants may also be added to the gum base compositions as is well known in the art.

Chewing gums incorporating the inventive gum bases may be prepared. In addition to the gum base, the chewing gums may typically include such ingredients as bulking agents, flavors, high intensity sweeteners, syrups, cooling agents and other sensates, colors, softeners, active ingredients and other components. The chewing gum may be prepared in many forms such as sugarless and sugar-containing gums, low moisture gums, high moisture gums, stick, tab and pellet forms, center filled compositions, compressed gums, Such products are well disclosed in the prior art.

What is claimed is:

1. A soy protein elastomer comprising a fraction of protein extracted from soy.

2. The elastomer of claim 1 wherein the elastomer is enriched in α and α′ subunits of β-conglycinin as compared to soy protein.

3. A method of preparing a soy protein elastomer comprising the steps of extracting a protein fraction from a native soy protein source using an aqueous solvent of pH between about 5.2 and about 5.7.

4. The method of claim 1, the pH of the aqueous solvent is between 5.3 and 5.6.

5. The method of claim 1, the pH of the aqueous solvent is between 5.3 and 5.5.

6. The method of claim 1, the pH of the aqueous solvent is about 5.4.

7. The method of any of claims 3 to 6 further comprising the step of collecting the soy protein elastomer at a pH at or below the isoelectric point.

8. A soy protein based elastomer which is the product of the method of any of claims 3 to 7.

9. A chewing gum base comprising a soy protein elastomer of any of claims 1, 2 or 8.
